(19) United States
(12) Patent Application Publication
(10) Pub. No.: US 2019/0314780 A1
(43) Pub. Date: Oct. 17, 2019

(54) HIGH TEMPERATURE REACTION DEVICE AND GRAPHENE MATERIAL PRODUCTION SYSTEM

(71) Applicant: Linde ZHANG, Shenzhen (CN)

(72) Inventor: Linde ZHANG, Shenzhen (CN)

(21) Appl. No.: 16/314,384

(22) PCT Filed: Jun. 29, 2017
(86) PCT No.: PCT/CN2017/090722

§ 371 Date: Dec. 28, 2018

(30) Foreign Application Priority Data
Jul. 8, 2016 (CN) 201610535028.4

(51) Int. Cl. B01J 6/00; B01J 19/00; C01B 32/184

(52) U.S. Cl. CPC B01J 6/008; B01J 19/0006; B01J 19/0013; B01J 2219/00051; B01J 2219/00164; B01J 2219/00162; C01B 32/184

(57) ABSTRACT

A high temperature reaction device includes a gas controlling unit, a powder controlling unit, a high temperature reaction unit, and a material collecting unit. The gas controlling unit controls a speed of an airflow at an inlet of the high temperature reaction unit. The powder controlling unit controls a speed of powder entering the airflow. The material collecting unit is connected to an outlet of the high temperature reaction unit to perform a gas-solid separation on a reacted material. After the reaction, the powder enters the material connecting unit and the material collection can be realized without the need of shutdown for cooling, thereby realizing a continuous reaction. In addition, the material collecting unit can quickly separate the gas and powder after reaction, thereby avoiding side reactions and further improving the purity of the powder material.

### CROSS REFERENCE TO RELATED APPLICATIONS

This application is the national phase entry of International Application No. PCT/CN2017/090722, filed on Jun. 29, 2017, which is based upon and claims priority to Chinese Patent Application No. 201610535028.4, filed on Jul. 8, 2016, the entire contents of which are incorporated herein by reference.

### TECHNICAL FIELD

The present invention relates to the technical field of chemical industry, in particular to a high temperature reaction device. In addition, the present invention further relates to a graphene material production system having the above high temperature reaction device.

### BACKGROUND

In the preparation, production, processing or modification process of many kinds of powder materials, higher temperatures are often required to promote the reaction. Sometimes, a specific atmosphere is required to protect the powder material to avoid oxidation or to make the atmosphere react with the powder material.

In traditional methods, a high-temperature high-speed pyrolysis of a soluble or easy-to-disperse system may be achieved by the method of spray pyrolysis or the like. Alternatively, reactions in high temperature atmosphere can be carried out in batches by using a car-bottom furnace, a kiln or a box furnace. However, the spray pyrolysis method is unsuitable for the difficult-to-disperse system or the sensitive solvent, and the spray pyrolysis has insufficient control on the atmosphere. While, the car-bottom furnace, kiln or box furnace often has problems that the material layer does not come in a full contact with the atmosphere, so reaction remains incomplete, the reaction time is difficult to control, and the reactions in these devices are performed in batches, which makes the production noncontinuous.

Therefore, how to design a high temperature reaction device capable of performing continuous reaction, with the reaction time controllable, is a technical problem that is urgently needed to be solved by those skilled in the art.

### SUMMARY

One objective of the present invention is to provide a high temperature reaction device capable of performing a continuous reaction and controlling the reaction time of the high temperature reaction. Another objective of the present invention is to provide a graphene material production system.

In order to achieve the above technical objectives, the present invention provides a high temperature reaction device which includes a gas controlling unit, a powder controlling unit, a high temperature reaction unit, and a material collecting unit. The gas controlling unit controls a speed of an airflow at an inlet of the high temperature reaction unit. The powder controlling unit controls a powder speed for entering the airflow. The material collecting unit is connected to an outlet of the high temperature reaction unit to perform a gas-solid separation on a reacted material.

Optionally, the gas controlling unit includes a gas source and an airflow controlling module. The gas source is connected to the inlet of the high temperature reaction unit through a pipeline. The airflow controlling module controls a flow rate and a pressure of the airflow in the pipeline.

Optionally, the powder controlling unit includes a stock bin and a discharging machine located at a lower side of the stock bin. A discharging port of the discharging machine is connected to the pipeline. The discharging machine controls a speed of the powder inside the stock bin for entering the pipeline.

Optionally, a pre-fluidization air inlet is further provided at a discharging port of the stock bin.

Optionally, the powder controlling unit further includes a mixing-blowing module. An air inlet of the mixing-blowing module is connected to the gas source through the pipeline. An air outlet of the mixing-blowing module is connected to the inlet of the high temperature reaction unit through the pipeline. The discharging port of the discharging machine is connected to a feeding port of the mixing-blowing module. The discharging machine controls a speed of the powder inside the stock bin for entering the mixing-blowing module.

Optionally, the gas controlling unit further includes a spiral air guiding plug, and the gas from the gas source enters the mixing-blowing module through the spiral air guiding plug.

Optionally, a main body of the spiral air guiding plug is provided with a plurality of inclined holes parallel to each other.

Optionally, a top of the stock bin is provided with a gas extracting port and a gas supplement port.

Optionally, the material collecting unit includes a dust remover with at least one stage and a cooling mechanism provided between the dust remover and the high temperature reaction unit.

The present invention also provides a graphene material production system which includes the high temperature reaction device according to any one of the above solutions.

The high temperature reaction device provided by the present invention includes a gas controlling unit, a powder controlling unit, a high temperature reaction unit, and a material collecting unit. The gas controlling unit controls a speed of an airflow at an inlet of the high temperature reaction unit. The powder controlling unit controls a powder speed for entering the airflow. The material collecting unit is connected to an outlet of the high temperature reaction unit to perform a gas-solid separation on a reacted material.

When the high temperature reaction device is in operation, the gas controlling unit controls the airflow at the inlet of the high temperature reaction unit, and the powder controlling unit controls the speed at which powder enters the airflow. The powder entered into the airflow forms an aerosol with the airflow. The concentration and flow rate of the aerosol are changed as the speed of the airflow and the speed at which the powder enters the airflow are changed. Accordingly, the aerosol can enter the high temperature reaction unit at different concentrations and flow rates. A time taken by the aerosol to pass through the high temperature reaction unit can be determined by the flow rate of the aerosol. After passing through the high temperature reaction unit, a reacted aerosol is subjected to a gas-solid separation by the material collecting unit, so as to collect the material while recovering the gas.

Compared with the prior art, the high temperature reaction device can realize continuous heat treatment on powder material in the high temperature atmosphere. The gas controlling unit can adjust the gas flow rate throughout the process to control the heating time of the powder in the high temperature reaction unit. Meanwhile, the powder material is continuously fed and discharged, and refluxed and heated in the high temperature section, or rapidly pyrolyzed in the high temperature section during the flow and transportation. After the reaction, the powder enters the material collecting unit, and the material can be collected without stopping the cooling, thereby realizing a continuous reaction. In addition, with material collecting unit, the gas and powder materials generated after the reaction are quickly separated and cooled, thereby avoiding side reactions and further improving the purity of the powder material.

The present invention also provides a graphene material production system, which includes the above high temperature reaction device. The high temperature reaction device has the above technical effects, so the graphene material production system also has corresponding technical effects.

### BRIEF DESCRIPTION OF THE DRAWINGS

FIG. 1 is a structural schematic diagram of a specific embodiment of the high temperature reaction device provided by the present invention; and

FIG. 2 is a structural schematic diagram of another specific embodiment of the high temperature reaction device provided by the present invention.

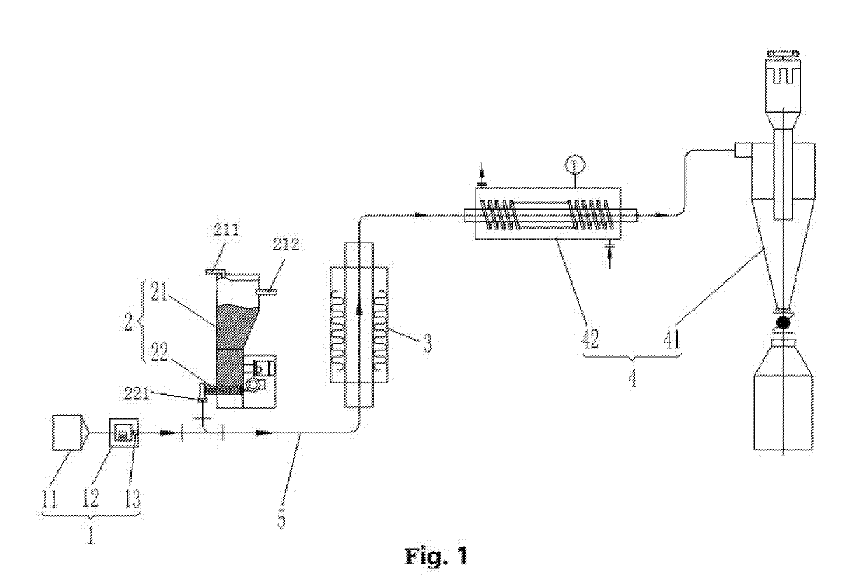

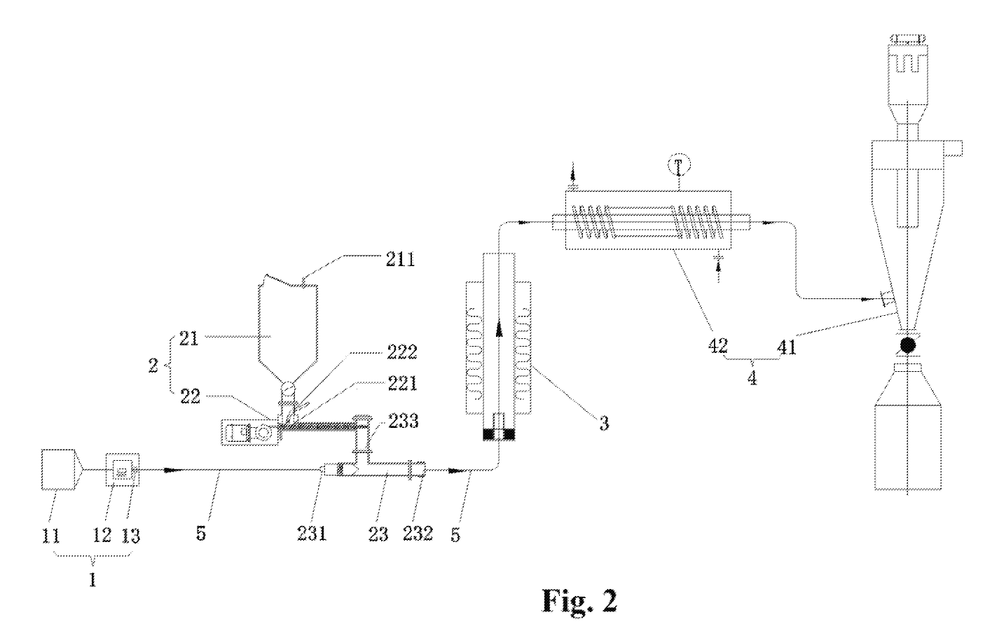

Where, the corresponding relationship between the reference numerals and the component names in FIGS. 1-2 is as follows:

gas controlling unit 1; gas source 11; airflow controlling module 12; spiral air guiding plug 13; powder controlling unit 2; stock bin 21; gas extracting port of the stock bin 211; gas supplement port of the stock bin 212; discharging machine 22; discharging machine discharging port 221; pre-fluidization air inlet 222; mixing-blowing module 23; the mixing-blowing module air inlet 231; mixing-blowing module air outlet 232; mixing-blowing module feeding port 233; high temperature reaction unit 3; material collecting unit 4; dust remover 41; cooling mechanism 42; and pipeline 5.

### DETAILED DESCRIPTION OF THE EMBODIMENTS

The objective of the present invention is to provide a high temperature reaction device capable of performing a continuous reaction and controlling the reaction time in the high temperature reaction. Another objective of the present invention is to provide a graphene production line.

In order to make the solution of the present invention more understandable for those skilled in the art, the present invention is further described in detail below with reference to the drawings and specific embodiments

Referring to FIG. 1, FIG. 1 shows a structural schematic diagram of a specific embodiment of the high temperature reaction device provided by the present invention.

In a specific embodiment, the present invention provides a high temperature reaction device which includes a gas controlling unit 1, a powder controlling unit 2, a high temperature reaction unit 3, and a material collecting unit 4. The gas controlling unit 1 controls a speed of an airflow at an inlet of the high temperature reaction unit 3. The powder controlling unit 2 controls a speed of the powder entering the airflow. The material collecting unit 4 is in connected to an outlet of the high temperature reaction unit 3 to perform a gas-solid separation on a reacted material.

When the high temperature reaction device is in operation, the gas controlling unit 1 controls the speed of the airflow at the inlet of the high temperature reaction unit 3, and the powder control unit 2 controls a powder speed for entering the airflow. The powder entered into the airflow forms an aerosol with the airflow. The concentration and flow rate of the aerosol are changed as the speed of the airflow and the speed of powder entering the airflow are changed. Accordingly, the aerosol can enter the high temperature reaction unit 3 at different concentrations and flow rates. A time taken by the aerosol to pass through the high temperature reaction unit 3 can be determined by the flow rate of the aerosol.

After passing through the high temperature reaction unit 3, a reacted aerosol is subjected to a gas-solid separation by the material collecting unit 4, so as to collect the material while recover the gas.

Compared with the prior art, the high temperature reaction device can realize continuous heat treatment on powder material in the high temperature atmosphere. The gas controlling unit 1 can adjust the gas flow rate throughout the process to control the heating time of the powder in the high temperature reaction unit 3. Meanwhile, the powder material is continuously fed and discharged, and refluxed and heated in the high temperature section, or rapidly pyrolyzed in the high temperature section during the flow and transportation. After the reaction, the powder enters the material collecting unit 4, and the material can be collected without stopping the cooling, thereby realizing a continuous reaction. In addition, with material collecting unit 4, the gas and powder materials generated after the reaction are quickly separated and cooled, thereby avoiding side reactions and further improving the purity of the powder material.

Further, according to a preferred embodiment, the gas controlling unit 1 includes a gas source 11 and an airflow controlling module 12. The gas source 11 is connected to the inlet of the high temperature reaction unit 3 through a pipeline 5. The airflow controlling module 12 controls a flow rate and a pressure of the airflow inside the pipeline 5.

The gas source can supply the gas required by the high temperature reaction unit 3. For example, if an oxidation reaction is required, an oxidizing gas is supplied, and if a reduction reaction is required, a reducing gas is supplied. The gas supplied from the gas source enters the high temperature reaction unit 3 through the pipeline 5, and the flow rate and pressure of the airflow inside the pipeline 5 are controlled by the airflow controlling module 12.

The airflow controlling module 12 controls the time for which the powder stays in the high temperature reaction unit by controlling the flow rate and pressure of the airflow inside the pipeline, thereby achieving the technical objective of long-time refluxing and heating and short-time rapid pyrolyzing of the material.

The airflow controlling module 12 may include a timer, a pressure gauge, an airflow controlling valve, a safety valve, etc. In order to prevent excessive pressure, the airflow controlling module 12 may be provided with a pressure gauge. When the pressure in the pipeline 5 exceeds the safety pressure, the air inflow may be stopped or the air exhausting may be started. A safety valve for emergency pressure relief may further be provided, which plays the role of an insurance, and will automatically discharging air once the pressure is excessive.

Further, according to a preferred embodiment, the powder controlling unit 2 includes a stock bin 21 and a discharging machine 22 located at a lower side of the stock bin 21. A discharging port 221 of the discharging machine 22 is connected to the pipeline 5. The discharging machine 22 controls the speed of the powder inside the stock bin 21 for entering the pipeline 5.

The powder is located inside the stock bin 21, and the gas inside the stock bin 21 is replaced with the same gas supplied from the gas source 11. The discharging machine 22 is located at the lower portion of the stock bin 21, and controls the powder speed for entering the pipeline 5, thereby controlling the concentration of the aerosol formed by the powder and the airflow. Specifically, the speed of the powder entering the pipeline 5 is set according to the specific reaction requirements.

The discharging port 221 of the discharging machine 22 may also be used as an air inlet for the gas to enter the stock bin 21. A valve may also be provided on the pipeline 5 for the sake of closing the passage between the gas source 11 and the high temperature reaction unit 3 when needed. For example, when the gas inside the stock bin 21 is replaced, the valve may be closed so that the all gas of the gas source 11 will pass through the discharging port 221 of the discharging machine 22 to enter the stock bin 21 to replace the original gas inside the stock bin 21.

Further, referring to FIG. 2, according to a preferred embodiment, a pre-fluidization air inlet 222 is further provided at a discharging port 221 of the stock bin 21. The pre-fluidization air inlet 222 is used for gas inflow, and pre-fluidizing the powder at the discharging port 221 of the stock bin 21. For the powder material that gets caked easily, the pre-fluidization can prevent the powder cake from blocking the discharging port 221, resulting in the problem that the material cannot be discharged smoothly.

Further, referring to FIG. 2, according to a preferred embodiment, the powder controlling unit 2 further includes a mixing-blowing module 23. An air inlet 231 of the mixing-blowing module 23 is connected to the gas source 11 through the pipeline 5. An air outlet 232 of the mixing-blowing module 23 is connected to the inlet of the high temperature reaction unit 3 through the pipeline 5. The discharging port 221 of the discharging machine 22 is connected to the feeding port 233 of the mixing-blowing module 23. The discharging machine 22 controls a speed of the powder inside the stock bin 21 for entering the mixing-blowing module 23.

The mixing-blowing module 23 includes an air inlet 231, an air outlet 232 and a feeding port 233. The gas from the gas source 11 enters the mixing-blowing module 23 from the air inlet 231 through the pipeline 5. The powder from the stock bin 21 enters the mixing-blow module 23 from the feeding port 233. The gas and the powder are sufficiently and effectively mixed in the mixing-blowing module 23 to form a uniform aerosol, and then the uniform aerosol leaves the mixing-blowing module 23 from the air outlet 232 and enters the high temperature reaction unit 3 through the pipeline 5.

Further, according to a preferred embodiment, the air outlet 232 of the mixing-blowing module 23 is provided with a venturi tube for controlling the pressure at the time when the gas is blown out from the mixing-blow module 23.

The mixing-blowing module 23 is connected to the inlet of the high temperature reaction unit 3. The pressure of the gas carrying the powder needs to be increased in order to ensure that the powder can be more efficiently transferred into the high temperature reaction unit 3. When the length of the pipeline 5 connected between the mixing-blowing module 23 and the inlet of the high temperature reaction unit 3 is relatively long, to control the speed of the airflow at the inlet of the high temperature reaction unit 3 merely by adjusting the airflow controlling module 12 the control force is relatively weak, and the heavier material is easy to fall down from the airflow. In this case, a venturi tube is provided at the air outlet 232 of the mixing-blowing module 23. The venturi tube enables the powder to be sent in a beam-like shape during the process that the powder is carried by the gas. The pressure at the inlet of the high temperature reaction unit 3 is further regulated by controlling the pressure at the time when the gas is blown out from the mixing-blowing module 23.

Further, a gas nozzle may also be provided at the air inlet 231 of the mixing-blowing module 23 for controlling the pressure at the time when the gas is blown into the mixing-blowing module 23. The gas nozzle described above may be a pressurizing nozzle.

A viewport may also be provided on the mixing-blowing module 23 to observe the mixing situation of the gas and solid in the mixing-blowing module 23.

Referring to FIG. 1 and FIG. 2, according to a specific embodiment, the gas controlling unit 1 further includes a spiral air guiding plug 13, and the gas from the gas source 11 enters the mixing-blowing module 23 through the spiral air guiding plug 13.

The gas from the gas source 11 passes through the spiral air guiding plug 13 and enters the pipeline 5 in a spiral shape. Also, the gas in the pipeline 5 presents as a spiral airflow. After the gas is mixed with the powder, the mixture of powder and gas still presents as spiral shape and enters the high temperature reaction unit 3. Compared with the air inflow with a straight flow, an eddy will occur in the straight flow, due to which a part of the powder cannot be blown inside, while the spiral airflow can ensure that all powder is blown into the high temperature reaction unit 3. In addition, if the powder falls into the venturi tube and the corresponding venturi mixer, the powder tends to accumulate in the venturi tube, while the spiral airflow facilitate the creation of eddy and can transport the powder out of the venturi tube.

Further, a main body of the spiral air guiding plug 13 is provided with a plurality of parallel inclined holes.

After the airflow enters the spiral air guiding plug 13, the air flows out along the plurality of parallel inclined holes through the preset air guiding ports on the spiral air guiding plug 13 to form a spiral airflow inside the pipeline 5. The inclination angle of the parallel inclined holes may be changed, and the flowing path of the spiral airflow may be adjusted according to different requirements.

Further, referring to FIG. 1 and FIG. 2, according to a specific embodiment, the top of the stock bin 21 is provided with an air extracting port 211 and an air supplement port 212. After the powder material is added into the stock bin 21, the atmosphere inside the stock bin 21 may be replaced for a plurality of times to make the atmosphere keep consistent with the atmosphere provided by the gas source 11. The air supplement port 212 may be provided on the side of the stock bin 21 for supplementing gas and replacing the atmosphere inside the stock bin 21 after the vacuumizing process is completed.

Preferably, the discharge machine 22 is a screw feeding machine or a vibration feeding machine. The rotation speed of the screw feeding machine is adjustable. With different rotation speeds of the screw feeding machine, different amounts of the powder material can enter the pipeline 5 and form different concentrations of aerosol with the airflow in the pipeline 5, and ultimately realizing the transport of the powder in dilute phase or dense phase and enter the high temperature reaction unit 3. In the operation process, the vibration feeding machine can uniformly, regularly, and continuously feed the blocky or granular materials from the stock bin into the pipeline 5 or the mixing-blowing module 23, so the material feeding is uniform, the operation is simple, and the maintenance is convenient.

In the various specific embodiments mentioned above, the high temperature reaction unit 3 may be a high temperature tube furnace. The inlet of the high temperature tube furnace is located at the bottom, and the outlet thereof is located at the top. The high temperature tube furnace may be a vertical high temperature tube furnace, which can realize the process requirements of different temperatures by controlling the temperature of the furnace. According to the process requirements, the furnace may be made of the material such as quartz, ceramic, tungsten tube, etc.

In various specific embodiments mentioned above, the material collecting unit 4 includes a dust remover 41 with at least one stage and a cooling mechanism 42 provided between the dust remover 41 and the high temperature reaction unit 3.

The dust remover 41 described above may be a gas-solid separation device such as a cyclone separator and/or a bag-type dust remover. The cyclone separator introduces the airflow tangentially, so as to make the airflow to rotate in the interior thereof with the enough inertial centrifugal force achieved to achieve the separation of solid and gas. The material collecting unit 4 may be provided with a multi-stage cyclone separator, and the number of stages of the cyclone separator is determined according to the needs in practical use to obtain an optimal separation effect. The size of the bag-type dust remover is much smaller than that of the cyclone separator, which facilitates the improvement of the size of the device.

After the reaction of the powder material in the high temperature reaction unit 3 is completed, the powder material leaves the high temperature reaction unit 3 with a high temperature atmosphere. The powder material and the high temperature are cooled down rapidly by the cooling mechanism 42 first, then sent to the dust remover 41 to realize the gas-solid separation, thereby avoiding damage to the dust remover 41 caused by the high temperature. The cooling mechanism 42 may be an air cooled finned tube and/or a water cooled finned tube. Preferably, the cooling mechanism 42 is a combination of air cooled finned tube and water cooled finned tube. The material passes through the air cooled finned tube first, and then passes through the water cooled finned tube in order to ensure the cooling efficiency.

The gas that needs to be recovered may be discharged from the upper port of the dust remover 41 and re-purified to achieve recovery. The powder material treated in high temperature is taken out from the collection tank of the dust remover 41 to complete the separation, and the collection tank may be replaced to continue the collection, so that the material discharging and the feeding are continuous.

Two specific embodiments of the present application will be described with reference to the drawings.

### Embodiment 1: Rapid Pyrolysis of a High Temperature Inert Atmosphere

The stock bin 21 is opened, and the powder material to be pyrolyzed is introduced into the stock bin 21. Then the stock bin 21 is vacuumized and the inert gas required for the system is blown in from the discharging port 221 of the discharging machine 22 and the air inlet of the stock bin 21. This step is repeated 2-3 times to complete the atmosphere replacement of the system.

The high temperature tube furnace is then turned on to make the temperature raise to the desired temperature required for the reaction. After the desired temperature is reached, the water inlet and water outlet of the cooling mechanism 42 are turned on to lower the temperature of the outflow gas of the high temperature tube furnace to an acceptable range.

Subsequently, the gas source 11 is turned on, and the airflow controlling module 12 is used to make the airflow stable and then enter the system. The residual air in the system is purged for a certain period of time (normally 5-30 min, but the time may be appropriately extended according to the required cleanliness), so that the system is turned into an inert atmosphere.

Upon completion, the discharging machine 22 is opened to adjust the material feeding speed and adjust the amount of intake air of the airflow controlling module 12, so that the powder can be sufficiently blown up by the airflow and a stable aerosol is formed and transported in the pipeline 5. The aerosol quickly passes through the high temperature tube furnace to complete the pyrolysis, and is sent to the dust remover 41 for separation, so as to obtain the target product, ultimately.

When the machine is going to be shut down, the discharging machine 22 is firstly closed, and the gas intake is continued for a period of time until no more new material is blown out from the collection tank of the dust remover 41. Then the high temperature tube furnace is turned off and the gas intake is stopped. When the temperature drops below 300° C., the water inflow and outflow of the cooling mechanism 42 are turned off, and the shutdown is completed.

### Embodiment 2: Refluxing and Heating of a High Temperature Oxidizing Atmosphere

The stock bin 21 is opened, and the powder material to be pyrolyzed is introduced into the stock bin 21. Then the stock bin 21 is vacuumized and the oxidizing atmosphere required for the system is blown in from the discharging port 221 of the vibration feeding machine and the air inlet of the stock bin 21. This step is repeated 2-3 times to complete the atmosphere replacement of the system. The high temperature tube furnace is then turned on to make the temperature raise to the desired temperature required for the reaction. After the desired temperature is reached, the water inlet and water outlet of the water cooled finned tube are turned on to lower the temperature of the outflow gas of the high temperature tube furnace to an acceptable range.

Subsequently, the gas source 11 is turned on, and the airflow controlling module 12 is used to make the airflow stable and then enter the system. The residual air inside the system is purged for a certain period of time (normally 5-30 min, and the time may be appropriately extended according to the required cleanliness), so that the system is turned into an oxidizing atmosphere.

Upon completion, the screw vibration feeding machine is turned on, and the powder material requiring heating under refluxing for the batch is added into the pipeline 5. Then the gas intake amount of the airflow controlling module 12 is adjusted, so that the powder material can be slowly pushed and suspended in the airflow. After the suspended powder enters the high temperature tube furnace, a certain balance is achieved due to its own gravity and the push of the airflow, so that the powder is heated and tumbled in the high temperature tube furnace and refluxing and heated in the form of a fluidized bed. After the heat treatment of the batch of material is completed, the gas intake amount of the gas controlling module 12 is adjusted. The material is sent out from the high temperature tube furnace and sent to the cyclone separator for separation after being cooled to obtain the target product, ultimately.

After the collection tank is replaced, the material feeding step is repeated to perform the heat treatment of the next batch. When the machine is going to be shut down, the spiral vibration feeding machine is firstly closed, the gas intake is continued for a period of time until no more new material is blown out from the collection bottle of the cyclone separator. Then, the high temperature tube furnace is turned off, and the air intake is stopped at the same time. When the temperature drops below 300° C., the water inflow and outflow of the water-cooled finned tube are closed and the shutdown is completed.

### Embodiment 3: Rapid Pyrolysis of a High Temperature Inert Atmosphere

The stock bin 21 is opened, and the powder material to be pyrolyzed is introduced into the stock bin 21, and the discharging port 221 of the screw feeding machine is closed. Then the stock bin 21 is vacuumized. The discharging port 221 of the screw feeding machine is gradually opened, and the inert gas fills up the entire stock bin 21. After that, the process of closing the discharging port 221—vacuumizing—introducing the inert gas is recirculated and repeated for 2 to 3 times, so as to complete the atmosphere replacement in the stock bin 21.

Meanwhile, the gas controlling unit 1 starts to purge the entire system except for the stock bin 21 with the inert gas for 5-30 minutes, and the time may be appropriately extended according to the required cleanliness, so that the entire system is turned into an inert gas environment. After the purging is completed, the airflow controlling module 12 is adjusted to reduce the amount of the airflow and maintain a continuous and relatively small airflow.

The discharging port 221 of the screw feeding machine is opened to make the material fall down to the head end of screw rod of the screw feeding machine. Since the inert gas with a low flow rate is continuously supplied, the material near the screw is in a slightly boiling state caused by the airflow, and no blocking will occur. The screw feeding machine is started and the material is sent from the head end of the screw rod to the tail end of the screw rod.

Meanwhile, the high temperature tube furnace is turned on to make the temperature of the high temperature tube furnace raise to the desired temperature required for the reaction. After the desired temperature is reached, the water inflow and outflow of the air cooled finned tube are turned on to lower the gas outflow temperature of the high temperature tube furnace to an acceptable range.

The airflow controlling module 12 is adjusted to a suitable speed. The material is transported by the screw rod to the mixing-blowing module 23, where the material is sufficiently and effectively mixed with the gas to form a uniform aerosol, and the uniform aerosol is blown into the high temperature tube furnace. The aerosol is pyrolyzed after passing through the high temperature tube furnace quickly, and is sent into the bag-type dust remover for separation to obtain the target product, ultimately.

In addition to the above high temperature reaction devices, the present invention further provides a graphene material production system which includes the high temperature reaction device described in any of the above embodiments.

The high temperature reaction device has the above-mentioned technical effects, so the graphene material production system having the high temperature reaction device also has corresponding advantages. For other devices of the graphene material production system, please refer to the prior art, and no further description is provided herein.

The high temperature reaction device and the graphene material production system provided by the present invention are described in detail above. The principles and implementations of the present invention have been described with reference to specific embodiments. The description of the above embodiments is merely used to facilitate the understanding of the method of the present invention and the core idea thereof. It should be noted that those skilled in the art can make various modifications and changes to the present invention without departing from the principle of the present invention, and such modifications and changes should also be considered as falling within the scope of the appended claims of the present invention.

What is claimed is:

1. A high temperature reaction device, comprising a gas controlling unit, a powder controlling unit, a high temperature reaction unit, and a material collecting unit;
wherein, the gas controlling unit controls a speed of an airflow at an inlet of the high temperature reaction unit;
the powder controlling unit controls a speed of powder entering the airflow; and
the material collecting unit is connected to an outlet of the high temperature reaction unit to perform a gas-solid separation on a reacted material.

2. The high temperature reaction device of claim 1, wherein,
the gas controlling unit comprises a gas source and an airflow controlling module;
the gas source is connected to the inlet of the high temperature reaction unit through a pipeline; and
the airflow controlling module controls a flow rate and a pressure of the airflow in the pipeline.

3. The high temperature reaction device of claim 2, wherein,
the powder controlling unit comprises a stock bin and a discharging machine located at a lower side of the stock bin;
a discharging port of the discharging machine is connected to the pipeline; and
the discharging machine controls a speed of powder inside the stock bin for entering the pipeline.

4. The high temperature reaction device of claim 3, wherein, a pre-fluidization air inlet is further provided at a discharging port of the stock bin.

5. The high temperature reaction device of claim 2, wherein,
the powder controlling unit further includes a mixing-blowing module;
an air inlet of the mixing-blowing module is connected to the gas source through the pipeline;
an air outlet of the mixing-blowing module is connected to the inlet of the high temperature reaction unit through the pipeline;
the discharging port of the discharging machine is connected to a feeding port of the mixing-blowing module; and
the discharging machine controls a speed of powder inside a stock bin for entering the mixing-blowing module.

6. The high temperature reaction device of claim 5, wherein, the gas controlling unit further comprises a spiral air guiding plug, and gas from the gas source enters the mixing-blowing module through the spiral air guiding plug.

7. The high temperature reaction device of claim 6, wherein, a main body of the spiral air guiding plug is provided with a plurality of inclined holes, and the plurality of inclined holes are parallel to each other.

8. The high temperature reaction device of claim 5, wherein, a top of the stock bin is provided with an air extracting port and an air supplement port.

9. The high temperature reaction device of claim 5, wherein, the material collecting unit comprises a dust remover with at least one stage and a cooling mechanism provided between the dust remover and the high temperature reaction unit.

10. A graphene material production system, comprising the high temperature reaction device claim 1.

11. The high temperature reaction device of claim 3, wherein,
the powder controlling unit further includes a mixing-blowing module;
an air inlet of the mixing-blowing module is connected to the gas source through the pipeline;
an air outlet of the mixing-blowing module is connected to the inlet of the high temperature reaction unit through the pipeline;
the discharging port of the discharging machine is connected to a feeding port of the mixing-blowing module; and
the discharging machine controls a speed of a powder inside the stock bin for entering the mixing-blowing module.

12. The high temperature reaction device of claim 4, wherein,
the powder controlling unit further includes a mixing-blowing module;
an air inlet of the mixing-blowing module is connected to the gas source through the pipeline;
an air outlet of the mixing-blowing module is connected to the inlet of the high temperature reaction unit through the pipeline;
the discharging port of the discharging machine is connected to a feeding port of the mixing-blowing module; and
the discharging machine controls a speed of a powder inside the stock bin for entering the mixing-blowing module.

13. The graphene material production system of claim 10, wherein the gas controlling unit comprises a gas source and an airflow controlling module;
the gas source is connected to the inlet of the high temperature reaction unit through a pipeline; and
the airflow controlling module controls a flow rate and a pressure of the airflow in the pipeline.

14. The graphene material production system of claim 13, wherein the powder controlling unit comprises a stock bin and a discharging machine located at a lower side of the stock bin;
a discharging port of the discharging machine is connected to the pipeline; and
the discharging machine controls a speed of powder inside the stock bin for entering the pipeline.

15. The graphene material production system of claim 14, wherein a pre-fluidization air inlet is further provided at a discharging port of the stock bin.

16. The graphene material production system of claim 14, wherein,
the powder controlling unit further includes a mixing-blowing module;
an air inlet of the mixing-blowing module is connected to the gas source through the pipeline;
an air outlet of the mixing-blowing module is connected to the inlet of the high temperature reaction unit through the pipeline;
the discharging port of the discharging machine is connected to a feeding port of the mixing-blowing module; and
the discharging machine controls a speed of powder inside the stock bin for entering the mixing-blowing module.

17. The graphene material production system of claim 16, wherein the gas controlling unit further comprises a spiral air guiding plug, and gas from the gas source enters the mixing-blowing module through the spiral air guiding plug.

18. The graphene material production system of claim 17, wherein a main body of the spiral air guiding plug is provided with a plurality of inclined holes, and the plurality of inclined holes are parallel to each other.

19. The graphene material production system of claim 16, wherein a top of the stock bin is provided with an air extracting port and an air supplement port.

20. The graphene material production system of claim 16, wherein the material collecting unit comprises a dust remover with at least one stage and a cooling mechanism provided between the dust remover and the high temperature reaction unit.
